(19) United States
(12) Patent Application Publication
(10) Pub. No.: US 2025/0161796 A1
(43) Pub. Date: May 22, 2025

(54) INFORMATION PROCESSING APPARATUS AND INFORMATION PROVISION METHOD

(71) Applicant: Sony Interactive Entertainment Inc., Tokyo (JP)

(72) Inventors: Shusuke KITAMURA, Tokyo (JP); Yuta MURATA, Tokyo (JP)

(73) Assignee: Sony Interactive Entertainment Inc., Tokyo (JP)

(21) Appl. No.: 18/837,205

(22) PCT Filed: Feb. 22, 2022
(86) PCT No.: PCT/JP2022/007348

§ 371 Date: Aug. 9, 2024

(51) Int. Cl. A63F 13/213; G06Q 50/12; G06V 20/52; G06V 20/68; G06V 40/10

(52) U.S. Cl. CPC A63F 13/213; G06Q 50/12; G06V 20/52; G06V 20/68; G06V 40/10

(57) ABSTRACT

An image processing section displays a display image on an output apparatus. A time acquisition section acquires a time during which a user is viewing the display image. A hunger estimation section estimates, from the time during which the user is viewing the display image, that the user is hungry. An information provision section provides the user with information regarding food in a case where the hunger estimation section estimates that the user is hungry.

### TECHNICAL FIELD

The present disclosure relates to a technology for providing users with information regarding food.

### BACKGROUND ART

In recent years, food delivery services for delivering food from restaurants to delivery destinations, such as homes, have rapidly become popular. When a user of such a food delivery service displays the menu of a restaurant on a terminal device, selects a product, and makes a payment, such order information is provided to the restaurant. Staff at the restaurant makes the product based on the provided order information, and delivery staff delivers the product to the user's home, allowing the user to eat the product made at the restaurant while staying at home.

### SUMMARY

### Technical Problem

Since the food delivery services are widespread, users are now able to easily eat food prepared at restaurants while staying at home. However, in a case, for example, where a user feels hungry while the user is playing a game, the user may miss the opportunity to order a food even if the user is feeling hungry, and just keep playing the game although the user is still hungry. Therefore, it is preferable that such a user be given the opportunity to order food. Further, eating is necessary to maintain and improve health. Therefore, it is preferable that users who are engrossed in a game and do not feel hungry be also given the opportunity to eat at an appropriate time.

Accordingly, an object of the present disclosure is to provide a technology for providing users with the information regarding food.

### Solution to Problem

In order to solve the above problem, according to an aspect of the present disclosure, there is provided an information processing apparatus including an image processing section, a time acquisition section, and an information provision section. The image processing section displays a display image on a display apparatus. The time acquisition section acquires a time during which a user is viewing the display image. The information provision section provides the user with information regarding food according to the time during which the user is viewing the display image.

According to another aspect of the present disclosure, there is provided an information provision method including a step of displaying a display image a step of acquiring a time during which a user is viewing the display image, and a step of providing the user with information regarding food according to the time during which the user is viewing the display image.

It should be noted that any combinations of the above-mentioned component elements and any conversions of expressions of the present disclosure between, for example, methods, apparatuses, systems, recording media, and computer programs are also effective as aspects of the present disclosure.

### BRIEF DESCRIPTION OF DRAWINGS

FIG. 1 is a diagram illustrating an information provision system according to an embodiment of the present disclosure.

FIG. 2 is a diagram illustrating a hardware configuration of an information processing apparatus.

FIG. 3 is a diagram illustrating the functional blocks of the information processing apparatus.

FIG. 4 is a diagram illustrating an example of a game image.

FIG. 5 is a diagram illustrating an example in which a system image is displayed superimposed on a game image.

FIG. 6 is a diagram illustrating an example in which a service selection window is displayed superimposed on a game image.

FIG. 7 is a flowchart illustrating the steps performed to provide a user with information regarding food.

FIG. 8 is a diagram illustrating an example of the service selection window superimposed on a game image.

FIG. 9 is a diagram illustrating an example of a selection window superimposed on a game image.

FIG. 10 is a diagram illustrating another example of a game image.

FIG. 11 is a diagram illustrating an example of a restaurant selection window superimposed on a game image.

FIG. 12 is a diagram illustrating an example of a product selection window superimposed on a game image.

### DESCRIPTION OF EMBODIMENTS

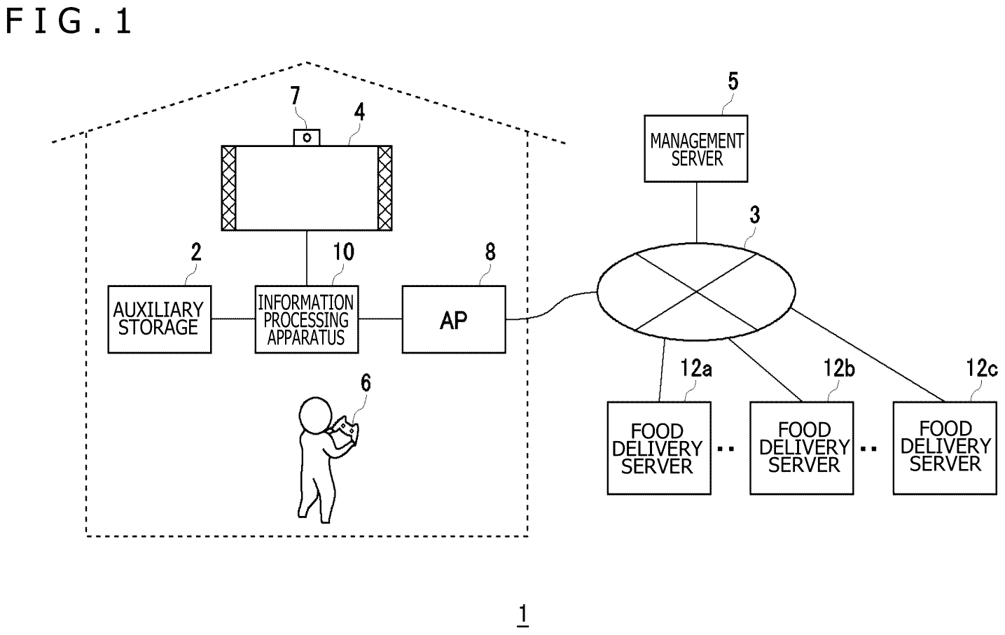

FIG. 1 illustrates an information provision system 1 according to an embodiment of the present disclosure. The information provision system 1 provides information regarding food to a user who is viewing content such as games and movies. The information provision system 1 includes an information processing apparatus 10, a management server 5, and food delivery servers 12a, 12b, and 12c (hereinafter referred to as the “food delivery servers 12” unless specifically distinguished). The information processing apparatus 10 is operated by the user. The food delivery servers 12 provide food delivery services to the user. The above-mentioned component elements are connected through a network 3 such as the Internet. The food delivery servers 12 are operated by food delivery service providers to allow the user to select a desired service from among a plurality of food delivery services.

An access point (hereinafter referred to as the “AP”) 8 has the functions of a wireless access point and the functions of a router. The information processing apparatus 10 is connected wirelessly or wired to the AP 8, and is communicatively connected to the management server 5 and food delivery servers 12 over the network 3.

An input apparatus 6 to be operated by the user is connected wirelessly or wired to the information processing apparatus 10. Upon receiving operating information from the user, the input apparatus 6 outputs the operating information to the information processing apparatus 10. Upon receipt of the operating information from the input apparatus 6, the information processing apparatus 10 reflects the operating information in the processing performed by system software and application software, and causes an output apparatus 4 to output the result of processing. In the embodiment, the information processing apparatus 10 may be a game console for executing a game program, and the input apparatus 6 may be a game controller. Alternatively, however, the information processing apparatus 10 may be a reproduction apparatus for reproducing content, such as movies, and the input apparatus 6 may be configured to include a plurality of input sections, such as a plurality of operating pushbuttons, an analog stick capable of inputting an analog quantity, and a rotary switch. It should be noted that the information processing apparatus 10 may be a mobile terminal, such as a smartphone or a tablet computer, and that an auxiliary storage 2, the output apparatus 4, the input apparatus 6, and a camera 7 may all be incorporated into a single mobile terminal. In such a case, the input apparatus 6 is a touch panel so that the user may input the operating information by operating the touch panel. Further, the input apparatus 6 may have a function of receiving the operating information that is inputted by a user's voice.

The auxiliary storage 2 is a storage such as an HDD (hard disk drive) or an SSD (solid-state drive), and may be a built-in storage or an external storage connected to the information processing apparatus 10 through, for example, a USB (Universal Serial Bus). The output apparatus 4 may be a television having a display for outputting images and a speaker for outputting a sound, or may be a head-mounted display. The camera 7 may be disposed near the output apparatus 4 to capture an image of a space where the user is present.

The management server 5 provides network services to the information processing apparatus 10. The management server 5 manages a network account for user identification so that the user uses the network account to sign in to a network service. After signing in to the network service, the user can use the network service provided by the management server 5. For example, the user can register, in the management server 5, game save data and virtual awards (trophies) acquired during game play.

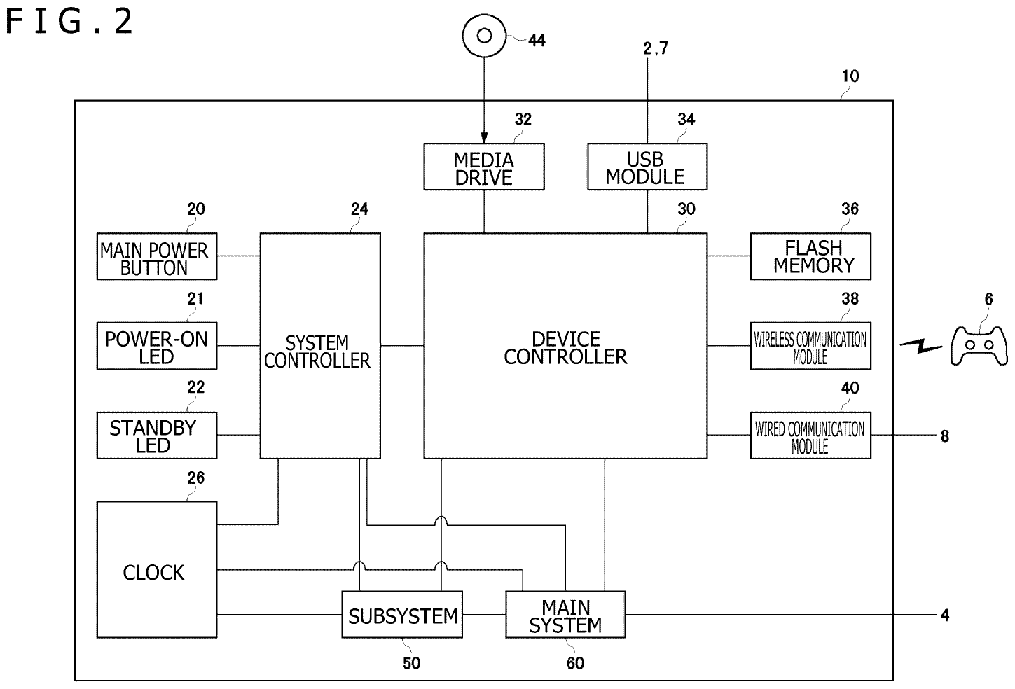

FIG. 2 illustrates a hardware configuration of the information processing apparatus 10. The information processing apparatus 10 includes a main power button 20, a power-ON LED (light-emitting diode) 21, a standby LED 22, a system controller 24, a clock 26, a device controller 30, a media drive 32, a USB module 34, a flash memory 36, a wireless communication module 38, and a wired communication module 40, a subsystem 50, and a main system 60.

The main system 60 includes, for example, a main CPU (Central Processing Unit), a memory serving as a main storage, a memory controller, a GPU (Graphics Processing Unit). The GPU is mainly used for arithmetic processing of game programs. These functions may be configured as a system-on-chip and formed on a single chip. The main CPU has a function of executing a game program that is recorded in the auxiliary storage 2 or in a ROM (read-only memory) medium 44.

The subsystem 50 includes, for example, a sub-CPU, a memory serving as a main storage, and a memory controller, but does not include a GPU and does not have a function of executing a game program. The number of circuit gates of the sub-CPU is smaller than the number of circuit gates of the main CPU, and the operating power consumption of the sub-CPU is smaller than the operating power consumption of the main CPU. The sub-CPU operates even while the main CPU is in a standby state, and the processing functions of the sub-CPU are limited in order to keep the power consumption low.

The main power button 20 is an input section through which the user inputs an operation, disposed on the front surface of the housing for the information processing apparatus 10, and operated to turn on or off the power supply to the main system 60 of the information processing apparatus 10. The power-ON LED 21 lights up when the main power button 20 is turned on, and the standby LED 22 lights up when the main power button 20 is turned off.

The system controller 24 detects the press of the main power button 20 by the user. When the main power button 20 is pressed while main power is turned off, the system controller 24 acquires such a pressing operation as an “ON instruction.” Meanwhile, when the main power button 20 is pressed while the main power is turned on, the system controller 24 acquires such a pressing operation as an “OFF instruction.”

The clock 26 is a real-time clock and configured to generate current date and time information and supply the generated information to the system controller 24, the subsystem 50, and the main system 60. The device controller 30 is configured as an LSI (Large-Scale Integrated Circuit) that transfers information between devices like a southbridge. As illustrated, the device controller 30 is connected to various devices such as the system controller 24, the media drive 32, the USB module 34, the flash memory 36, the wireless communication module 38, the wired communication module 40, the subsystem 50, and the main system 60. The device controller 30 absorbs the differences in electrical characteristics and data transfer rate between the individual devices, and controls the timing of data transfer.

The media drive 32 accepts and drives the ROM medium 44 in which games and other application software (hereinafter sometimes referred to simply as the “applications”) and license information are recorded, and reads, for example, programs and data from the ROM medium 44. The ROM medium 44 may be a read-only recording medium such as an optical disk, a magneto-optical disk, or a Blu-ray disk.

The USB module 34 is a module that is connected to external equipment by using a USB cable. The USB module 34 may be connected to the auxiliary storage 2 and the camera 7 using a USB cable. The flash memory 36 is an auxiliary storage that forms an internal storage. The wireless communication module 38 wirelessly communicates, for example, with the input apparatus 6 in compliance with a communication protocol such as the Bluetooth (registered trademark) protocol or the IEEE (Institute of Electrical and Electronics Engineers) 802.11 protocol. The wired communication module 40 performs wired communication with the external equipment, and connects with the external network 3 through the AP 8.

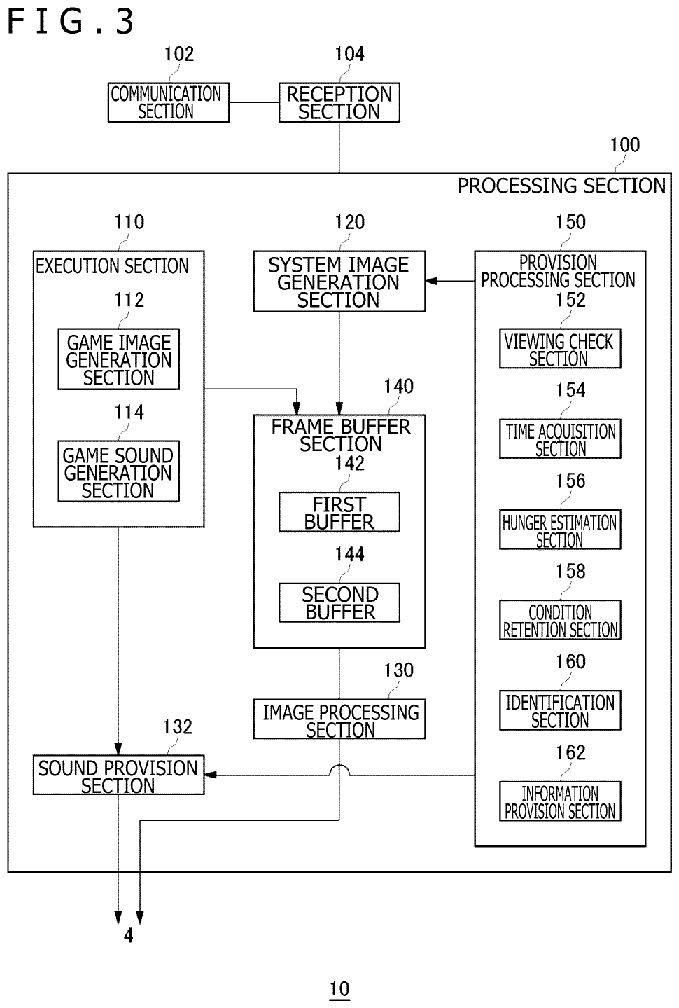

FIG. 3 illustrates the functional blocks of the information processing apparatus 10 that provides the user with information regarding food. The information processing apparatus 10 includes a processing section 100, a communication section 102, and a reception section 104. The processing section 100 includes an execution section 110, a system image generation section 120, an image processing section 130, a sound provision section 132, a frame buffer section 140, and a provision processing section 150.

The execution section 110 includes a game image generation section 112 and a game sound generation section 114. The frame buffer section 140 includes a plurality of frame buffers for temporarily storing image data, namely, a first buffer 142 and a second buffer 144. In the embodiment, the first buffer 142 temporarily stores a game image, and the second buffer 144 temporarily stores a system image. The provision processing section 150 includes a viewing check section 152, a time acquisition section 154, a hunger estimation section 156, a condition retention section 158, an identification section 160, and an information provision section 162.

The information processing apparatus 10 includes a computer that executes programs to implement various functions depicted in FIG. 3. Hardware provided in the computer includes a memory for loading a program, one or more processors for executing the loaded program, an auxiliary storage, and other LSIs. The processors are each formed by a plurality of electronic circuits including a semiconductor integrated circuit and an LSI. The plurality of electronic circuits may be mounted on a single chip or on a plurality of chips. The functional blocks depicted in FIG. 3 are implemented through cooperation between hardware and software. Therefore, it will be understood by those skilled in the art that the functional blocks may be variously implemented by hardware only, by software only, or by a combination of hardware and software.

The communication section 102 receives operating information regarding user operations performed on the input section of the input apparatus 6. Further, the communication section 102 transmits and receives information, such as data and instructions, to and from the management server 5 and the food delivery servers 12. The functional blocks of the communication section 102 are configured to have the functions of both the wireless communication module 38 and the wired communication module 40, which are depicted in FIG. 2.

The reception section 104 is provided between the communication section 102 and the processing section 100, and configured to transmit information, such as data and instructions, between the communication section 102 and the processing section 100. Upon receiving the operating information regarding the input apparatus 6 through the communication section 102, the reception section 104 supplies the received operating information to a predetermined functional block in the processing section 100.

The execution section 110 executes a game program (hereinafter sometimes referred to simply as a “game”). The functional blocks depicted as the execution section 110 is implemented by system software, game software, and hardware such as a GPU (Graphics Processing Unit). In response to the result of game program execution, the game image generation section 112 generates game image data, and the game sound generation section 114 generates game sound data. It should be noted that a game is an example of an application, and the execution section 110 may execute an application other than a game. For example, the execution section 110 may execute a video reproduction application to reproduce video data such as movies.

While the user is playing a game, the execution section 110 executes the game program to perform arithmetic processing as needed to move a game character in a virtual space according to the operating information that is inputted to the input apparatus 6 by the user. The game image generation section 112 includes a GPU for performing, for example, a rendering process, receives the result of arithmetic processing in the virtual space, generates game image data from a viewpoint position (virtual camera) in the virtual space, and stores the generated game image data in the first buffer 142. The image processing section 130 generates a display image from the game image data stored in the first buffer 142, and displays the generated display image on the output apparatus 4. At the same time, the game sound generation section 114 generates game sound data in the virtual space, and supplies the generated game sound data to the sound provision section 132. The sound provision section 132 causes the output apparatus 4 to output a game sound based on the game sound data. The user plays the game while viewing and listening to the game image and sound that are outputted from the output apparatus 4.

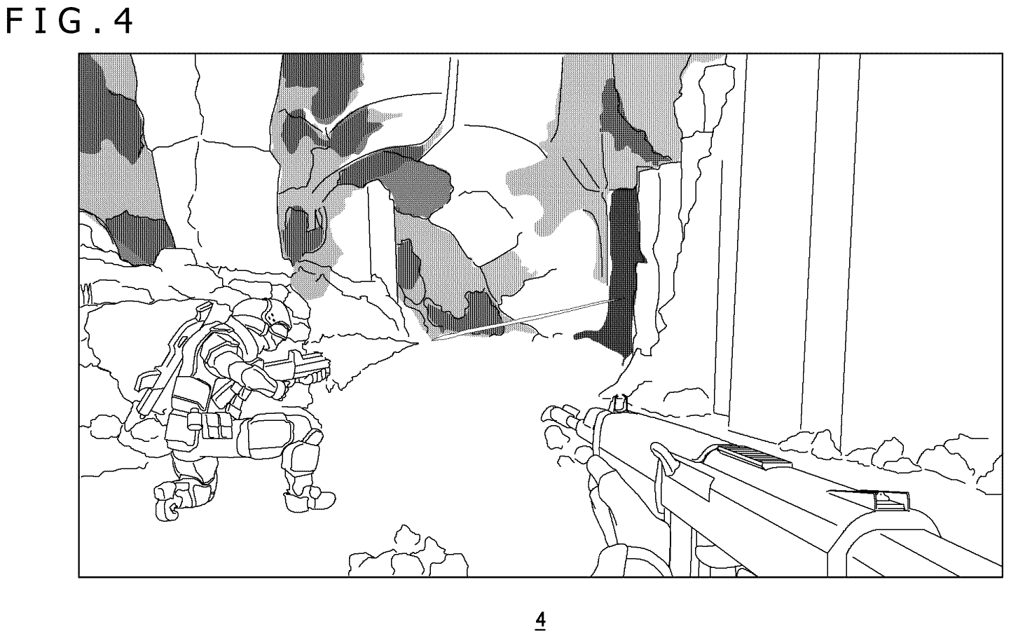

FIG. 4 illustrates an example of a game image that is displayed on the output apparatus 4. The user operates the input apparatus 6 to play the game while viewing and listening to the game image and sound that are outputted from the output apparatus 4. When the user briefly presses a predetermined button on the input apparatus 6 during game play, the reception section 104 accepts the brief pressing of the predetermined button, and supplies information regarding the brief pressing of the predetermined button to the system image generation section 120. The system image generation section 120 generates a system image including a plurality of menu items, and stores the generated system image in the second buffer 144. The image processing section 130 reads the game image from the first buffer 142 and the system image from the second buffer 144, generates a display image by combining the game image and the system image, and displays the generated display image on the output apparatus 4. When the system image is displayed superimposed on the game image, the reception section 104 supplies subsequently received operating information to the system software instead of the game software.

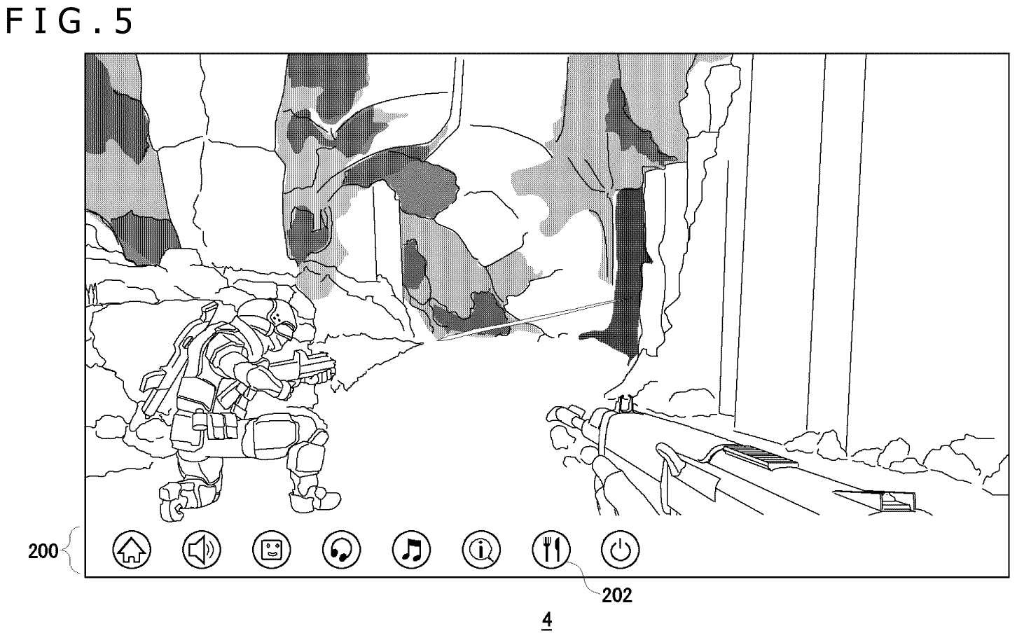

FIG. 5 illustrates an example in which a system image including menu icons is displayed superimposed on a game image. The image processing section 130 sets a function icon selection area 200 at the bottom of a display screen, and disposes a plurality of menu icons side by side. By selecting a menu icon, the user can perform a system function associated with the selected menu icon. The plurality of menu icons include a food icon 202 for selecting a food delivery service application.

When the reception section 104 receives the operating information for selecting the food icon 202, the system image generation section 120 generates a system image including food delivery service options, and stores the generated system image in the second buffer 144. The image processing section 130 generates a display image by superimposing the system image, which is read from the second buffer 144, on the game image, which is read from the first buffer 142, and displays the generated display image on the output apparatus 4.

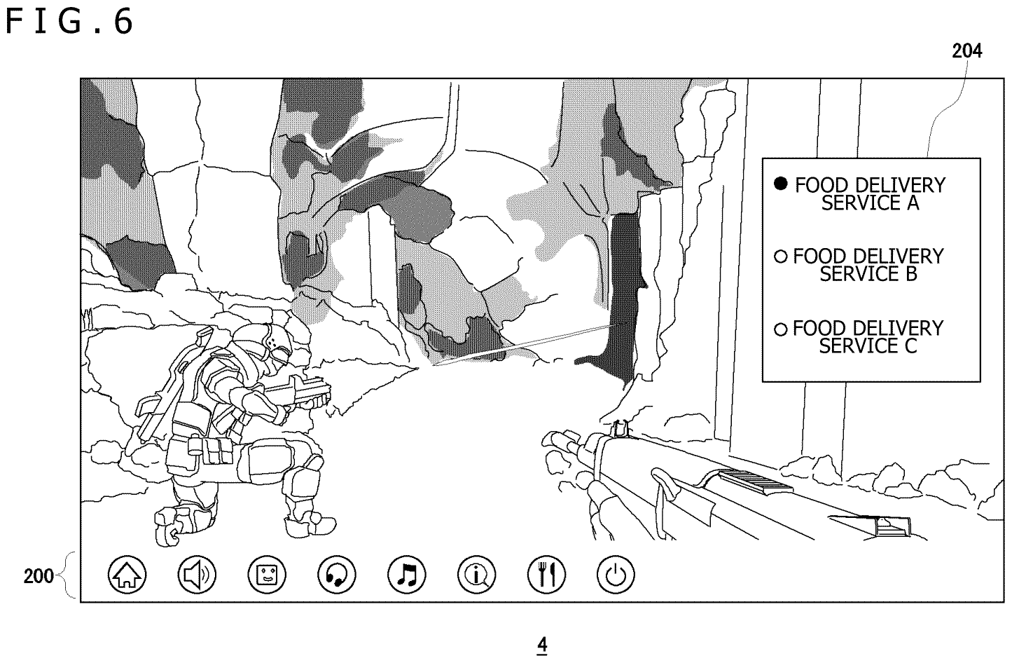

FIG. 6 illustrates an example in which a service selection window 204 is displayed superimposed on a game image. The service selection window 204 displays a plurality of options for choosing an application that provides food delivery services. For example, when the user selects food delivery service A in the service selection window 204, an application providing food delivery service A starts up to allow the user to order food from a menu provided by the food delivery server 12a.

As described above, when the user feels hungry during game play, the user can start a food delivery service application and order food. However, in a case where a tense game scene continues, the user may miss the opportunity to interrupt the game play, and may continue playing the game with an empty stomach. Therefore, the information processing apparatus 10 according to the embodiment has a function of estimating the hunger of the user from a game being played. When the user is estimated to be hungry, the information processing apparatus 10 provides the user with information regarding food, and operates to give the user the opportunity to order food.

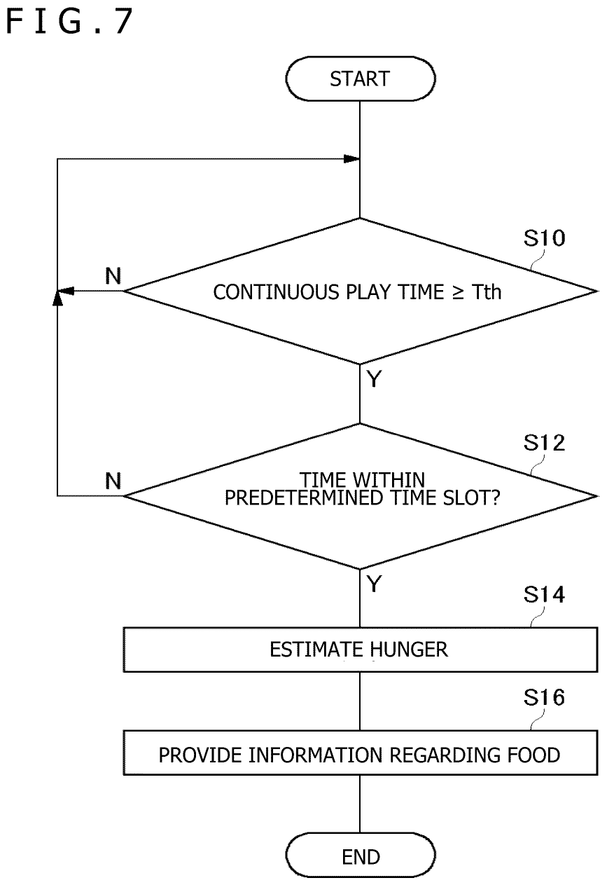

FIG. 7 is a flowchart illustrating the steps performed to provide the user with the information regarding food. The viewing check section 152 determines whether or not the user is viewing the display image displayed on the output apparatus 4. Specifically, the viewing check section 152 may monitor the situation where the reception section 104 is receiving the operating information from the input apparatus 6 in order to determine whether or not the user is viewing the display image (game image). If the time during which the reception section 104 does not receive the operating information (no-operation time) exceeds a predetermined time (e.g., 10 minutes), the viewing check section 152 may determine that the user is not viewing the display image. Meanwhile, as long as the no-operation time does not exceed the predetermined time, the viewing check section 152 may determine that the user is viewing the display image. Further, the viewing check section 152 may monitor an image captured by the camera 7, recognize that the user is present in front of the output apparatus 4, and thus determine that the user is viewing the display image.

The time acquisition section 154 receives the result of determination by the viewing check section 152, and acquires the time during which the user is viewing the display image. Specifically, the time acquisition section 154 derives the time during which the user continues to view the display image from the result of determination by the viewing check section 152. For example, if the viewing check section 152 continues to determine that the user is viewing the display image from the start time of game play by the user to the current time, the time acquisition section 154 acquires the time interval between the game play start time and the current time as the time during which the user continues to view the display image. The time during which the user continues to view the game image will be hereinafter referred to as the “continuous play time.”

The condition retention section 158 retains conditions (hunger determination conditions) for determining whether or not the user is hungry. The hunger determination conditions include at least a first condition and a second condition. The first condition is related to the time during which the user continues to view the display image. The second condition is related to a time slot. The hunger estimation section 156 uses the hunger determination conditions to estimate whether or not the user is hungry.

Specifically, the hunger estimation section 156 compares the continuous play time with a predetermined time threshold Tth (S10). The time threshold Tth constitutes the first condition among the hunger determination conditions. If the continuous play time is less than the time threshold Tth (“N” at step S10), the first condition among the hunger determination conditions is not satisfied. In this case, the hunger estimation section 156 estimates that the user is not hungry. Meanwhile, if the continuous play time exceeds the time threshold Tth (“Y” at step S10), the hunger estimation section 156 determines that the first condition among the hunger determination conditions is satisfied.

When the first condition is satisfied, the hunger estimation section 156 determines whether or not the current time is within a predetermined time slot (step S12). A plurality of time slots within a day may be predetermined. For example, a lunch time slot from 12:00 to 14:00 and a dinner time slot from 19:00 to 21:00 may be set as the predetermined time slots. It should be noted that only one predetermined time slot or three or more predetermined time slots may be set within a day. The predetermined time slot constitutes the second condition among the hunger determination conditions. If the time at which the first condition is satisfied is not within the predetermined time slot (“N” at step S12), the second condition among the hunger determination conditions is not satisfied. In this case, the processing returns to step S10, in which a first condition determination process is performed. Meanwhile, if the time at which the first condition is met is within the predetermined time slot (“Y” at step S12), the hunger estimation section 156 determines that the second condition among the hunger determination conditions is met.

If the first condition is satisfied by the time during which the user is viewing the display image and the second condition is satisfied by the time at which the first condition is satisfied, the hunger estimation section 156 estimates that the user is hungry (step S14). For example, if the continuous play time reaches the time threshold Tth (3 hours) (first condition satisfied) and the current time is 20:00 (second condition satisfied), the hunger estimation section 156 estimates that the user is hungry. Alternatively, the hunger estimation section 156 may skip the use of the second condition among the hunger determination conditions, and when only the first condition is satisfied, may estimate that the user is hungry. As described above, based at least on the time the user is viewing the display image, the hunger estimation section 156 in the embodiment estimates that the user is hungry.

When the hunger estimation section 156 estimates that the user is hungry, the information provision section 162 provides the user with the information regarding food (step S16). That is, the information provision section 162 provides the user with the information regarding food according to the time the user is viewing the display image. For example, the information provision section 162 may cause the system image generation section 120 to generate a system image including the information regarding food, and display the information regarding food on the output apparatus 4. It should be noted that the information provision section 162 may generate sound data of the information regarding food, supply the generated sound data to the sound provision section 132, and cause the sound provision section 132 to output the information regarding food as an audio output from the output apparatus 4.

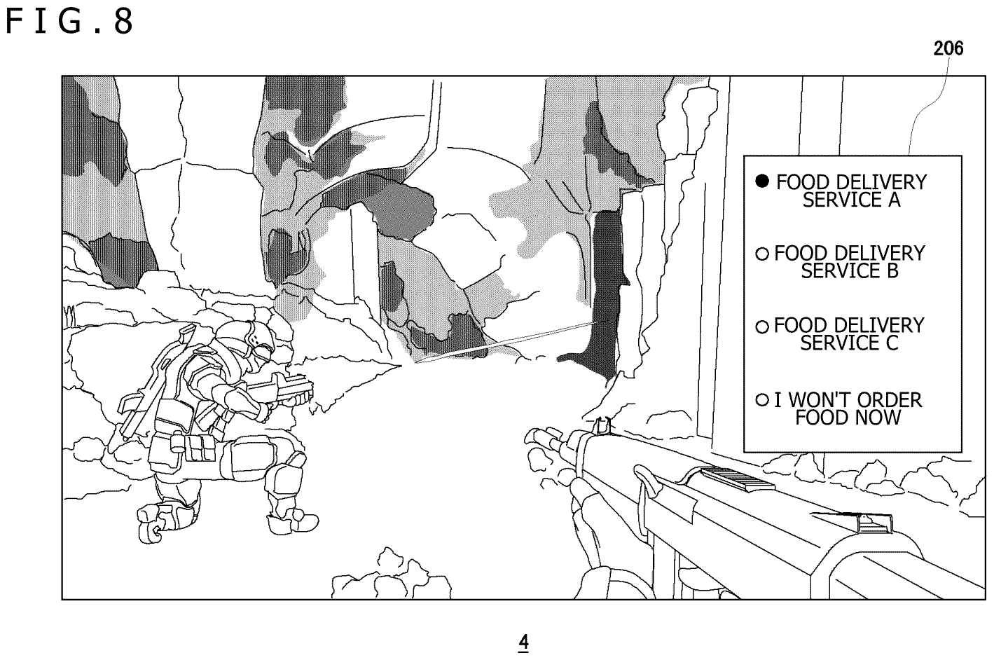

FIG. 8 illustrates an example of a service selection window 206 that is superimposed on the game image during game play. When the hunger determination conditions are satisfied during game play, the information provision section 162 provides the user with information regarding food delivery. The service selection window 206 depicted in FIG. 8 is an example of information regarding food delivery. The information provision section 162 may instruct the system image generation section 120 to generate the service selection window 206. The system image generation section 120 generates a system image including the service selection window 206, and stores the generated system image in the second buffer 144. The image processing section 130 generates a display image by superimposing the system image, which is read from the second buffer 144, on the game image, which is read from the first buffer 142, and displays the generated display image on the output apparatus 4.

The service selection window 206 displays not only a plurality of options for choosing an application that provides food delivery services, but also the option of not ordering food. Unlike the service selection window 204 (see FIG. 6), which is displayed according to the user's intention, the service selection window 206 is automatically displayed by the provision processing section 150. Therefore, the option of not ordering food is additionally displayed to allow the user to choose an option that suits the user's situation.

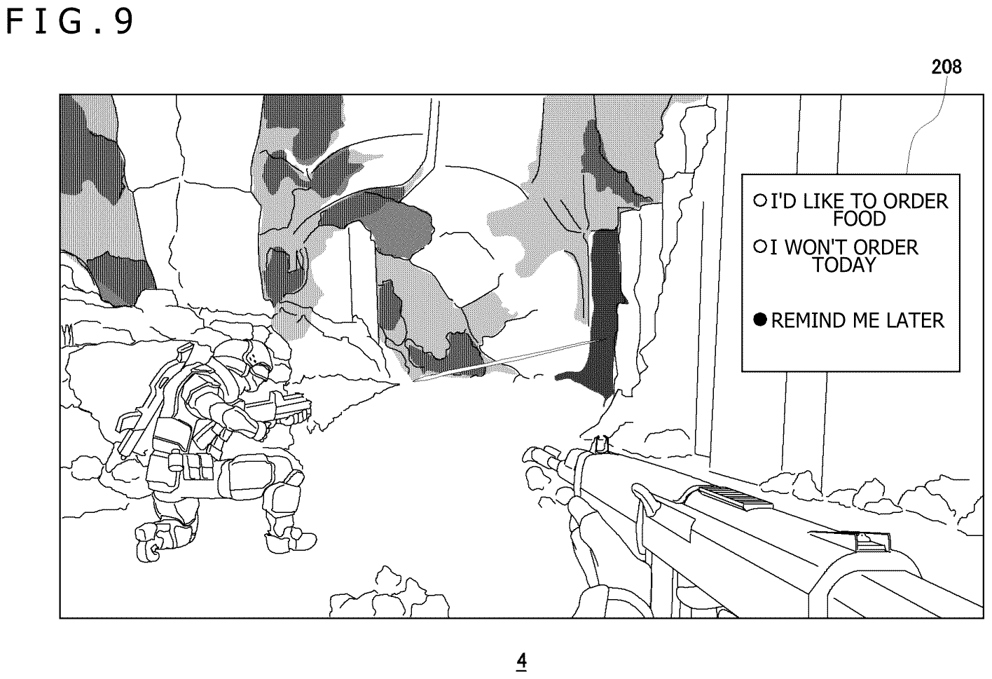

FIG. 9 illustrates an example of a selection window 208 that is superimposed on the game image during game play. When the hunger determination conditions are satisfied during game play, the information provision section 162 provides the user with a plurality of options as the information regarding food delivery. The selection window 208 displays the options, namely, “I'd like to order food,” “I won't order today,” and “Remind me later.” When the user selects “I'd like to order food” from among the displayed options, the provision processing section 150 displays the service selection window 204 or the service selection window 206 on the game image, allowing the user to select a food delivery service.

If the user selects “I won't order today,” the provision processing section 150 ends today's operation, that is, ends the execution, for example, of a user's hunger determination process. It should be noted that the provision processing section 150 may resume the above-mentioned operation after 12 midnight today. Meanwhile, if the user selects “Remind me later,” the hunger estimation section 156 determines whether or not the hunger determination conditions are satisfied after the elapse of a predetermined time (e.g., one hour later). In a case where the hunger estimation section 156 estimates that the user is hungry, the information provision section 162 may provide the user with the information regarding food.

It should be noted that the information provision section 162 may provide information regarding food other than food delivery service options.

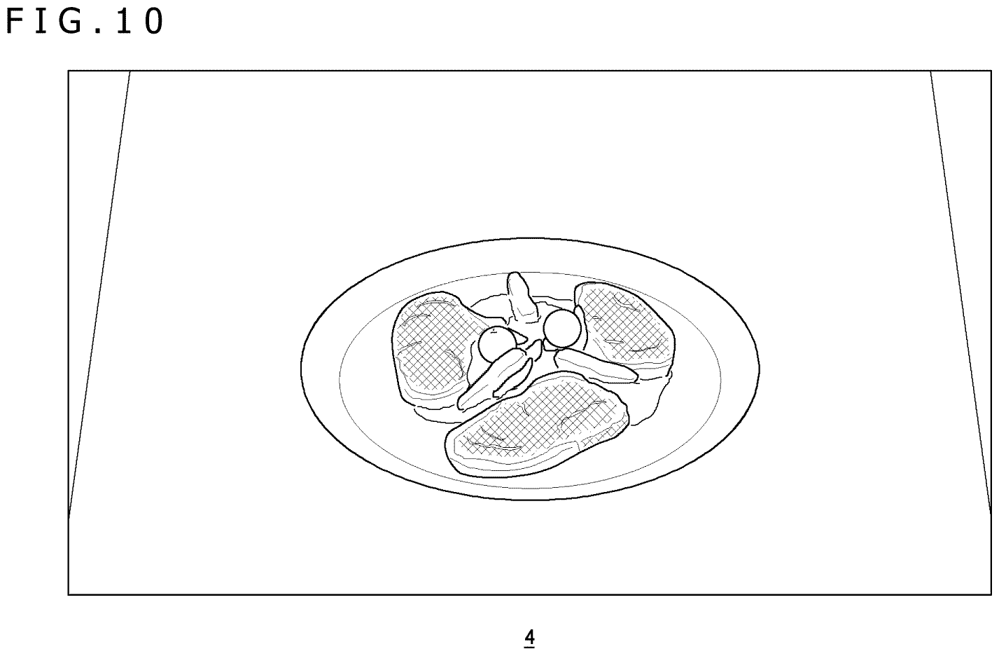

FIG. 10 illustrates another example of the game image displayed on the output apparatus 4. The game image in FIG. 10 depicts, for example, a scene where a game character is eating, and a plate containing meat is placed on a dining table. The identification section 160, which has an image recognition function, analyzes the display image, and identifies the food depicted in the display image. In the illustrated example, the identification section 160 identifies that meat is depicted in the game image illustrated in FIG. 10.

In a case where the hunger determination conditions are satisfied, the information provision section 162 may provide information regarding the food identified by the identification section 160. That is, in this case, the information provision section 162 provides information regarding meat.

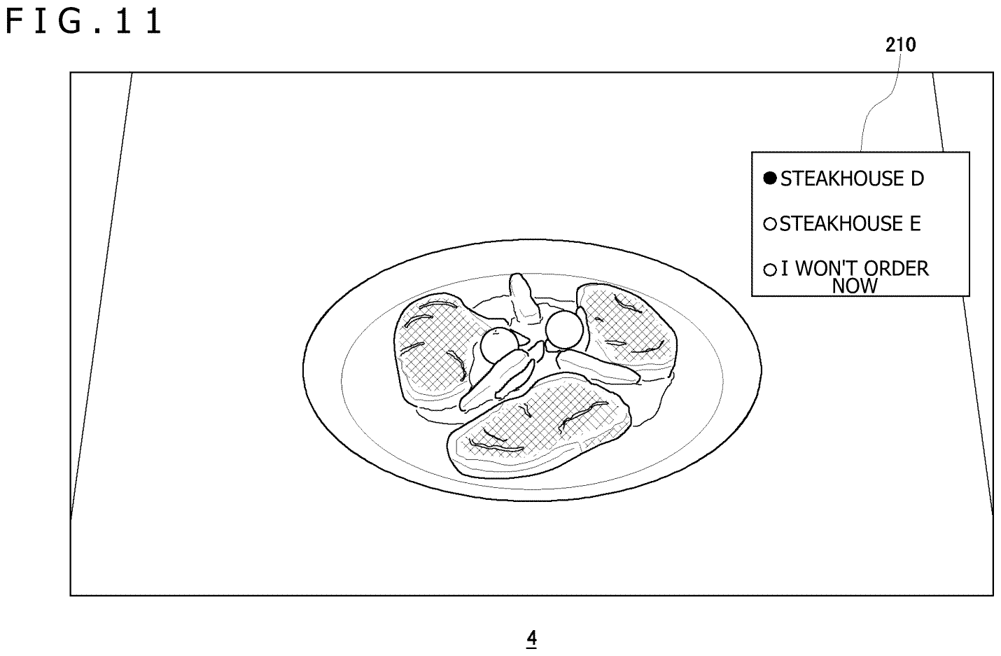

FIG. 11 illustrates an example of a restaurant selection window 210 that is superimposed on the game image during game play. When the hunger determination conditions are satisfied during game play, the information provision section 162 provides the user with the information regarding food delivery in order to indicate restaurants where the user can order the food identified by the identification section 160. The restaurant selection window 210 displays options for choosing a nearby restaurant where the user can order “meat.”

By providing the user with the information regarding the food identified by the identification section 160, the information provision section 162 allows the user in the real world to easily order food that a game character eats in a game world. For example, when the user orders food by operating the restaurant selection window 210, the game software may control a physical strength parameter so that the game character restores its physical strength. When the game world and the real world are linked in the above manner, it is possible to enhance the sense of immersion in a game.

It should be noted that the information provision section 162 may provide the user with information for ordering specific food. When the user preregisters restaurants to order from and products to order, the information provision section 162 displays the information in the game image so as to allow the user to order a specific one of the preregistered products in a situation where the hunger determination conditions are satisfied.

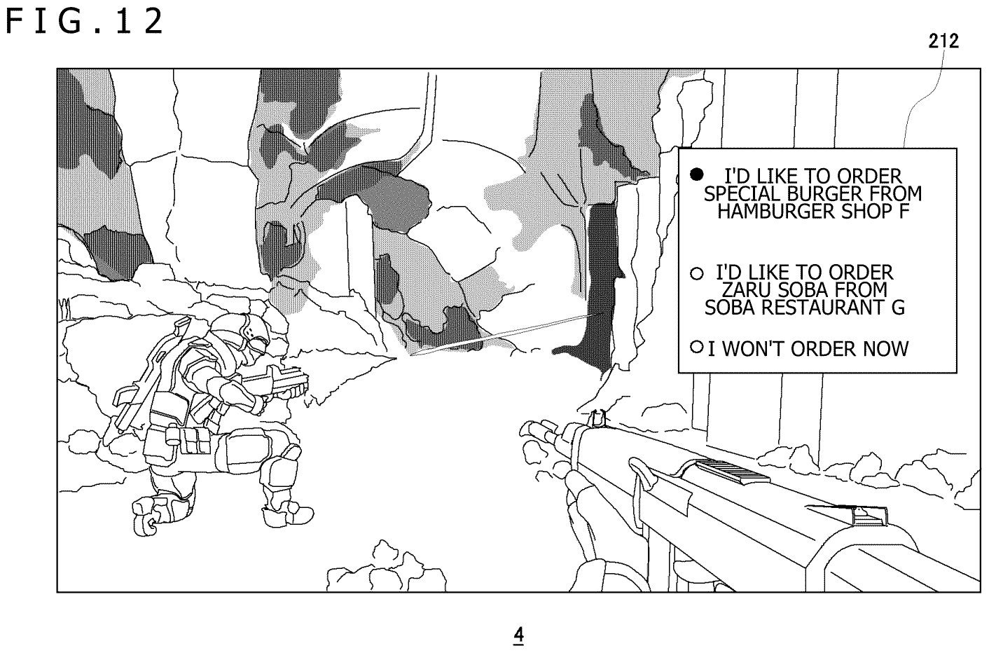

FIG. 12 illustrates an example of a restaurant selection window 212 that is superimposed on the game image during game play. When the hunger determination conditions are satisfied during game play, the information provision section 162 provides the user with the information regarding food delivery so as to allow the user to order food that is preregistered by the user. The restaurant selection window 212 displays options for choosing food preregistered by the user.

It should be noted that the information provision section 162 may provide the information regarding food at a time when the user is not performing any operation on the game. For example, in an online multiplayer fighting game, the user may retire early and have some free time. If the hunger determination conditions are satisfied, the information provision section 162 may provide the user with the information regarding food at a time when the game software notifies the information provision section 162 that the user has retired from the game.

As described above, upon estimating that the user is hungry, the information processing apparatus 10 according to the embodiment provides the user with the information regarding food. The information processing apparatus 10 according to the embodiment provides the user with the information regarding food during game play not only when the user is actually feeling hungry, but also when the user is too engrossed in the game to feel hungry. This gives the user the opportunity to pause game play and order food.

The present disclosure has been described above in terms of the foregoing embodiment. It is to be understood by those skilled in the art that the foregoing embodiment is merely an example, and that the combination of component elements and processing processes described in conjunction with the foregoing embodiment can be variously modified, and further that such modifications are also within the scope of the present disclosure.

In the embodiment, the hunger estimation section 156 uses the hunger determination conditions to estimate whether or not the user is hungry. However, in a case, for example, where the hunger determination conditions are not satisfied, the hunger estimation section 156 may alternatively estimate the level of hunger according to a condition achievement rate. The hunger level may be expressed as a numerical value with an upper limit of 100%. In a case where the continuous play time is less than the time threshold Tth of the first condition, the hunger estimation section 156 may calculate the hunger level to be equal to (continuous play time/time threshold Tth)×100%. The hunger estimation section 156 may cause the system image generation section 120 to generate a system image including the calculated hunger level, and display the generated system image on the output apparatus 4. For example, the hunger level may be displayed in a small size in the corner of the game image, and as the continuous play time increases, the numerical value indicating the hunger level may be updated to approach 100%.

It should be noted that the user may be allowed to change the displayed hunger level. For example, if the user snacks while playing a game, a numerical value indicating a high hunger level may be displayed in the corner of the game image even though the user is not feeling hungry. For example, if the message “Estimated hunger level 80%” is displayed, it is preferable that the user be allowed to change the displayed numerical value to a hunger level that suits the user's sense. Specifically, the user may change the displayed message, for example, to “Estimated hunger level 10%.” In a case where the hunger level is changed by the user, the hunger estimation section 156 may update the continuous play time to be equal to the time threshold Tth x (new hunger level (%) set by user). For example, if the time threshold Tth is 3 hours and the hunger level is changed by the user to 108, the hunger estimation section 156 may change the continuous play time up to the current time to 0.3 hours, resume measuring the play time from 0.3 hours, and determine whether or not the first condition is satisfied.

The execution section 110 may execute an application other than game software, such as a video reproduction application. In a case where the video reproduction application is executed, the hunger estimation section 156 may measure the time during which the video is being reproduced, and derive the time during which the user continues to view the display image.

### Industrial Applicability

The present disclosure can be applied in the technical field of providing information regarding food.

### REFERENCE SIGNS LIST

1: Information provision system
4: Output apparatus
5: Management server
6: Input apparatus
10: Information processing apparatus
12a, 12b, and 12c: Food delivery server
100: Processing section
102: Communication section
104: Reception section
110: Execution section
112: Game image generation section
114: Game sound generation section
120: System image generation section
130: Image processing section
132: Sound provision section
140: Frame buffer section
142: First buffer
144: Second buffer
150: Provision processing section
152: Viewing check section
154: Time acquisition section
156: Hunger estimation section
158: Condition retention section
160: Identification section
162: Information provision section

1. An information processing apparatus comprising:
processing circuitry configured to
display a display image on a display;
acquire a time during which a user is viewing the display image; and
provide the user with information regarding food according to the time during which the user is viewing the display image.

2. The information processing apparatus according to claim 1, wherein the processing circuitry is further configured to:
estimate, from the time during which the user is viewing the display image, that the user is hungry, wherein,
in response to the estimation corresponding to the user being hungry, provide the user with the information regarding food.

3. The information processing apparatus according to claim 2, wherein the processing circuitry is further configured to
use hunger determination conditions to estimate whether or not the user is hungry,
wherein the hunger determination conditions include at least a first condition and a second condition, the first condition being related to the time during which the user continues to view the display image, the second condition being related to a time slot.

4. The information processing apparatus according to claim 3, wherein the processing circuitry is further configured to
in response to the first condition being satisfied by the time during which the user is viewing the display image and the second condition is satisfied by the time at which the first condition is satisfied, estimate that the user is hungry.

5. The information processing apparatus according to claim 1, wherein the processing circuitry is further configured to
identify food depicted in the display image, and
provide information regarding the identified food.

6. The information processing apparatus according to claim 1, wherein the processing circuitry is further configured to
provide information regarding food delivery.

7. The information processing apparatus according to claim 1, wherein the processing circuitry is further configured to
provide the information regarding food at a timing when the user is not performing any operation on a game.

8. The information processing apparatus according to claim 1, wherein the processing circuitry is further configured to
provide information for ordering specific food.

9. An information provision method comprising:
displaying a display image;
acquiring a time during which a user is viewing the display image; and
providing the user with information regarding food according to the time during which the user is viewing the display image.

10. A non-transitory computer-readable storage medium storing computer-readable instructions thereon which, when executed by a computer, cause the computer to perform a method, the method comprising:
displaying a display image;
acquiring a time during which a user is viewing the display image; and
providing the user with information regarding food according to the time during which the user is viewing the display image.

11. The information provision method of claim 9, further comprising:
in response to the estimation corresponding to the user being hungry, providing the user with the information regarding food.

12. The information provision method of claim 11, further comprising:
using hunger determination conditions to estimate whether or not the user is hungry,
wherein the hunger determination conditions include at least a first condition and a second condition, the first condition being related to the time during which the user continues to view the display image, the second condition being related to a time slot.

13. The information provision method of claim 11, further comprising:
in response to the first condition being satisfied by the time during which the user is viewing the display image and the second condition is satisfied by the time at which the first condition is satisfied, estimating that the user is hungry.

14. The information provision method of claim 9, further comprising:
identifying food depicted in the display image; and
providing information regarding the identified food.

15. The information provision method of claim 9, further comprising:
providing information regarding food delivery.

16. The information provision method of claim 9, further comprising:
providing the information regarding food at a timing when the user is not performing any operation on a game.

17. The information provision method of claim 9, further comprising:
providing information for ordering specific food.

18. The information processing apparatus according to claim 1, wherein the processing circuitry is further configured to
monitor an image captured by a camera to recognize user presence,
determine that the user is viewing the display image based on recognizing the user presence in the captured image, and
acquire the time during which the user is viewing the display image based on the determination from the camera monitoring.

19. The information processing apparatus according to claim 1, wherein the processing circuitry is further configured to
receive a notification from game software indicating that the user has retired from an online multiplayer game,
determine that the user is not performing any operation on the game based on the notification, and
provide the information regarding food specifically during the determined time when the user is not performing any operation on the game.

20. The information processing apparatus according to claim 1, wherein the processing circuitry is further configured to
calculate a hunger level as a numerical percentage based on a ratio of the acquired viewing time to a predetermined time threshold,
display the calculated hunger level in a corner of the display image,
receive user input adjusting the displayed hunger level to a new percentage value, and
update the acquired viewing time based on multiplying the predetermined time threshold by the new percentage value set by the user.
